(19) United States
(12) Patent Application Publication
(10) Pub. No.: US 2006/0105845 A1
(43) Pub. Date: May 18, 2006

(54) Synchronized sliding joint

(76) Inventor: Sobhy Labib Girguis, Troisdorf (DE)

Correspondence Address: FRIEDRICH KUEFFNER, 317 MADISON AVENUE, SUITE 910, NEW YORK, NY, 10017, US

(21) Appl. No.: 10/513,609

(22) PCT Filed: Apr. 30, 2003
(86) PCT No.: PCT/EP03/04478

§ 371 Date: Jan. 17, 2006

(30) Foreign Application Priority Data
May 8, 2002 (DE) 102 20 836.0

(51) Int. Cl. F16D 3/26

(52) U.S. Cl. 464/111

(57) ABSTRACT

The invention relates to a synchronized sliding joint comprising a hollow outer part having three-grooves extending axially on the periphery with at least three opposite-lying tracks, an inner part located inside the outer part and comprising three journals which are directed radially in an outward direction and an outer roller which is placed around each journal and which rolls off on one of the tracks, being guided along a plane connecting the opposite-lying tracks and which is displaceably and pivotally arranged in relation to the journal. In order to ensure low-friction guidance of the outer rollers (3) with little or extremely little rotational backlash, the track (10, 10′) is embodied in a concave, V-shape with two sections (11, 11′;12, 12′) and the outer roller (3) is embodied in a convex, V-shape with two central (32, 32′) and two lateral sections (31, 31′). The lateral sections (31, 31′) respectively engage inside the track (10 or 10) with a respective contact point (B1, B2), and a respective gap (113, 113′) is provided between the central sections (32, 32′) and the sections (11, 11′) of the track.

The invention concerns a constant-velocity telescopic joint in accordance with the introductory clause of claim 1. DE 37 16 962 A1 describes a joint of this type, in which an outer roller with a V-shaped profile is guided in a track of the same profile parallel to the axis of the outer member, wherein two conical sections of the outer roller interact with two flat sections of the track. As a result of production tolerances, especially of the track profiles, guidance of this type with two line contacts at an angle to each other is highly overdetermined, i.e., imprecise. This can cause the outer roller to swing out of its guide plane or tilt and cause large frictional forces. Large surface pressures and edge loads also occur.

A pivoting motion of the outer roller in the cross section of the outer member can easily lead to intense frictional contact of the roller with the unloaded track. To be sure, this can be avoided by increasing the diametrical play of the rollers in the opposite tracks; however, the latter correspond to an increase in the rotational play of the joint. A pivoting motion of the outer roller in the longitudinal section of the outer member leads to a tilt of the roller relative to the rolling direction, so that a sliding friction component is added.

DE 37 16 962 A1 further describes that the outer roller can also be designed in the reverse manner, i.e., provided with a concave profile, and paired with a convex track. In this case, the centers of the pivoting movements of the roller are located completely outside the region of the roller in the cross section of the outer member, as a result of which the path of the pivoting movement in the region of the unloaded track becomes even larger.

DE 37 16 962 A1, furthermore, describes a joint design in which the outer roller is cylindrical on the inside and encloses a pivot roller, which is supported without freedom to slide on the journal by a needle bearing. The outer roller makes linear contact with the pivot roller, which shifts radially with respect to the joint due to the joint kinematics and thus acts on the outer roller with a tilting moment in the cross section of the outer member. This makes guidance of the outer roller more difficult and increases friction.

The objective of the present invention is to develop a joint of the type described above which, even in the case of relatively coarse tolerances, allows reliable transmission and low-friction guidance of the outer rollers with low to extremely low rotational play.

To achieve this objective, the invention proposes the features of the characterizing clause of claim 1. The two-point contact results in a clear determination of the position of the outer roller, and such contact can also be produced with greater accuracy. Furthermore, a large distance between the contact points is made possible by their arrangement on the lateral sections of the outer roller. The outer roller can thus be guided more stably and precisely during force transmission, with a correspondingly wide gauge on two tracks. The forces acting axially on the outer roller can also be advantageously absorbed by this type of two-point contact.

The arrangement allows limited pivoting movement of the outer roller in the cross section of the outer member. The center of this pivoting movement is determined principally by the design of the lateral sections of the outer roller, and the pivot angle is limited positively by the surfaces of the central sections of the outer roller and the tracks.

A tolerance-dependent or play-dependent pivoting movement of the outer roller in the longitudinal section of the outer member basically does not occur due to the two-point contact, but a certain capacity for elastic pivoting is present due to the flexibility of the contact regions. The latter, as well as the play-dependent pivoting movement in the cross section of the outer member, decrease under larger loads.

The profiles of the lateral and central sections of the roller can be arranged tangentially. This produces a gap which widens continuously from the contact point towards the plane of symmetry of the outer roller making contact in a conventional way, so that the contact surfaces, when loaded, can extend over both adjacent sections of the roller. The surface pressure can be determined within broad limits by the design of the roller profiles and track profiles.

In addition, the profiles of the central roller sections and those of the track sections can have the same design, so that linear contact between the two sections can be achieved while the pivoting movement is limited at the same time. The torques of the pivoting movement can therefore be absorbed effectively as well. A common transmission and support surface can then form, which is located in a relatively limited radial region of the outer roller, as a result of which only a small amount of slip is added to the rolling friction on the circumference of the roller.

The pivot angle can usually be minimized by designing the gap to accommodate only the maximum production tolerances. If the maximum shape tolerances of the adjacent surfaces are specified to be within 0.2°, for example, then the gap angle can be set at a value between zero and 0.2°. The maximum play-dependent pivot angle of the unloaded outer roller in the cross section of the outer member could thus be ±0.2°, and the minimum could be zero and thus more-or-less eliminated in the limit case. If the tolerances are even narrower, the gap angles can thus be smaller as well, and as a result lower surface pressures can also be obtained.

A minimum gap angle of, for example, 0.3°, can also be specified, however, in which case the pivot angle would be between ±0.3° and ±0.5°. An increase in the pivot angle does not by any means have to mean an increase in the amount of diametrical play.

In a simple design of the pairing of the outer roller with the track, the sections of the track can be designed to be flat, and the central sections of the outer roller can be designed to be conical. The angle enclosed between the profile lines of the conical sections of the outer roller is then slightly greater than the angle between the profile lines of the flat sections of the track. To produce the point contact between the outer roller and the flat track surfaces, the profiles of the lateral sections of the roller must be formed as convex crowns.

The profiles of the respective track sections can also be convexly curved, however, and the profiles of the central sections of the outer roller can be concavely curved, such that the narrow gap assumes a crescent shape. This significantly improves the guidance of the roller and its support. To produce the point contact between the outer roller and the flat track surfaces, the profiles of the lateral sections of the roller can have a straight, convex, or even concave design.

In addition, the profile centers of the lateral sections of the outer roller can lie on the lines that connect the respective contact point with the center of the roller. The outer roller can thus be pivoted at least approximately about its center in both torque directions, and in this case the pivoting distances will be the same on both the loaded and the unloaded track. It is also possible, of course, for the lateral sections of the outer roller to be spherical.

In the previously described pairings of the outer roller with the track, the elastic pivoting movement of the outer roller in the longitudinal section of the outer member is dependent on shape and the load, so that undesirably large pivot angles can occur under certain conditions. Therefore, an additional basic idea of the invention consists in providing a base between the tracks, which base has a convex, V-shaped, symmetrical design in the cross section of the outer member, wherein the central, elevated edge of the base has a certain amount of play relative to the flat surface of the outer roller to limit the pivoting movement of the outer roller in the longitudinal section of the outer member, and wherein the deeper lateral flanks of the base always have clearance from the opposite flat surface of the outer roller, so that the pivoting movement of the outer roller in the cross section of the outer member is not limited by the base.

Compared to the flat base, which is known in and of itself, the V-shape is very advantageous. First, the pivoting movement of the outer roller in the longitudinal section of the outer member is centrally supported by the edge in both torque directions, and this minimizes friction. In this connection, the pivoting movement of the outer roller in the cross section of the outer member remains independent of the base and is limited, for example, only by the loaded tracks themselves. Therefore, the play between the base and the flat surface of the outer roller can be minimized, which also limits the tilt of the roller relative to the rolling direction.

The slant of the base flanks can be designed itself to be only slightly greater than the maximum pivot angle of the outer roller in the cross section of the outer member. During the back-and-forth movement of the roller, contact occurs between the rear edge of the radially outer flat surface of the roller and the tip of the V-shape of the base. This can easily lead to the formation of a wedge of lubricant between the flat surface of the outer roller and the respective flank. The roller pivots back and forth in the cross section of the outer member twice per rotation of the joint. In addition, the V-shape also offers more space for more generous formation of the transition surfaces between the tracks and the base and for weight reduction of the outer member.

Only the edge formed by two flanks is actually occupied by the base. A transition radius between the flanks or a cylindrical surface can also perform this function, and in this case a larger surface would be available for supporting the outer roller periodically pivoting in the cross section of the outer member.

As in the case of the joint described at the beginning, the outer roller can have a cylindrical bore, in which an externally spherical pivot roller is guided, which is supported without freedom to slide on the journal by a needle bearing. In this connection, the guidance of the outer roller must absorb a kinematically produced tilting moment.

The outer roller can, however, have a hollow spherical bore, in which an externally spherical pivot roller is guided, which is supported with freedom to slide on the journal by a needle bearing. Although the tilting moment can be eliminated in this way, efficient, quiet, and play-free transmission cannot be guaranteed. For the purpose of fitting the spherical, pivot roller into the hollow, spherical outer roller, the pivot roller or the outer roller is usually provided with flat surfaces or grooves in the spherical surface. This, however, destroys the spherical symmetry of the spherical plain bearing. During the back-and-forth motion of the rollers, these types of recesses can easily and repeatedly pass through the line of force transmission, which results in unfavorable spontaneous intensification of the friction of the pairing. This causes overloading of the guidance of the outer roller, and the friction spontaneously increases to an excessive degree.

Therefore, the invention basically proposes that the hollow, spherical inner surface of the outer roller be formed without interruption in the circumferential direction and that the average wall thickness of the pivot roller be made significantly greater than the average wall thickness of the outer roller. The pivot roller is mounted by inserting it transversely into the outer roller under radial or oval elastic deformation, primarily of the outer roller.

The elimination of the mounting openings results in a strengthening of the roller in question, which means that the wall thickness of the spherically symmetrical roller can be reduced. To all intents and purposes, the reduction of the wall thickness of the outer roller can be largely tolerated as far as the force transmission is concerned but leads to a greater than proportional increase in its radial elasticity. On the other hand, an increase in the wall thickness of the pivot roller leads to a greater than proportional increase in its radial rigidity, which makes it possible to increase the transmission efficiency of the needle bearing or the number of load-bearing needles. Specifically, the elasticity of a spherically symmetrical roller is inversely proportional, more-or-less, to the square of its wall thickness, and the rigidity is directly proportional, more-or-less, to the square of its wall thickness.

In the case of spherically symmetrical rollers, the uninterrupted spherical outer surface of the pivot roller can roll smoothly over the uninterrupted hollow, spherical inner surface of the outer roller to form a load-bearing elastohydrodynamic film of lubricant. This significantly reduces the bore friction and greatly damps the transmission of vibration.

In another embodiment of a joint according to the invention, the outer roller is designed as an outer ring of a needle bearing without freedom to slide. The journal in this case can be elliptical with the major axis extending in the direction of rotation, and the bore of the inner ring can be in the form of a convex crown. The torque between the journal and the inner ring is then transmitted by pivoting point contact, as a result of which a kinematically produced tilting moment acts on the outer ring.

By pairing a spherical journal with a hollow, cylindrical inner ring, the torque can be transmitted by linear contact, and the geometrically produced diametrical play can be eliminated. A kinematically produced tilting moment, however, continues to act on the outer roller.

In another embodiment, the inner ring of a sliding needle bearing has a hollow, spherical design, and the journal has a spherical design. The needle bearing, however, must be free to slide, which means that the outer roller, despite the spherical pairing, is nevertheless affected by the kinematically produced tilting moment.

The tilting moment can be eliminated, however, by designing the outer roller as the outer ring of a nonsliding needle bearing, by giving the inner ring a hollow, spherical design, and by providing an externally spherical, internally cylindrical pivot roller between the inner ring and a cylindrical journal. Here too, for the purpose of fitting the pivot roller into the inner ring, flat surfaces are conventionally provided on the pivot roller, or grooves are provided on the inner ring in the region of the spherical surfaces. It is therefore possible for the flat surfaces or grooves to cross the line of force transmission when the pivot roller, i.e., the inner ring, turns relative to the journal.

Therefore, it is proposed that the spherical surface of the pivot roller and the spherical surface of the inner ring be designed to be uninterrupted in the circumferential direction, and that the average wall thickness of the pivot roller be made significantly smaller than the average wall thickness of the inner ring. In this case, the elastic deformation of the pivot roller is the critical factor for the transverse insertion of the pivot roller into the inner ring. Basically, therefore, the roller, which does not interact with the roller bearing, is designed with a thinner wall. This pivot roller could in fact be designed with a very thin wall, since it is pressed by surface contact on both sides.

To avoid the kinematically produced tilting moment as well as the turning of any mounting openings which may be present, the invention proposes that the outer roller be designed as the outer ring of a nonsliding needle bearing, that the inner ring have a hollow, spherical design, and that an externally spherical pivot roller be provided between the inner ring and the journal, where the pairing of the journal and the pivot roller is designed with a noncircular cross section. In this joint design, the pivot roller must be able to slide along the journal for kinematic reasons, but the pivot roller does not have to rotate. The relative rotational movement between the outer roller and the journal can be taken over by the easy-running needle bearing.

A noncircular, e.g., oval, journal with the major axis in the circumferential direction can lead both to an increase in torque transmission and to an increase in the maximum joint bending angle. When the rotational movement is eliminated, the sliding surfaces can be tribologically optimized so as to take only the sliding movement into account.

The nonrotating pivot roller can then be equipped with openings in the axial direction of the joint to allow simple transverse insertion in the inner ring. As a result of the nonrotatable mounting of the pivot roller on the journal, the openings remain away from the transmission surfaces.

The nonrotating pivot roller can also consist of two shells to allow simple insertion into the inner ring. Parts of this type can be produced inexpensively and provide low sliding friction. In correspondence with the coefficients of friction, the spherical-surface bearings of the previously described joints are subjected to only slight axial loads in comparison to the forces to be transmitted radially. Therefore, the arc measure of the hollow, spherical surface of the outer roller can be small, e.g., about 10°. This would still provide a safe distance from the self-locking angle. This limitation saves space and allows easy assembly in all of the designs of the pivot rollers.

Finally, the invention proposes that the pivot roller be spherical only in a central region, the width of which corresponds approximately to the width of the hollow, spherical region of the outer roller or inner ring surrounding it. The profiles of the lateral regions can be rounded or chamfered so that they have less material than lateral regions with a spherical surface.

The ovality required during the elastic installation of the rollers can be minimized in this way. The load-bearing capacity of the spherical pairings, however, remains undiminished, even under bending. In cases where the parts are assembled by the application of pressure, furthermore, the lateral regions can be designed as sliding surfaces. Any slight damage, e.g., scratching, which might occur to these surfaces is completely acceptable, because they are obviously outside the functional spherical surfaces themselves.

Naturally, the teaching of the invention allows the arrangement of the profiles of the outer roller and the track of claim 1 to be reversed by making the outer roller convexly V-shaped with two sections and the track concavely V-shaped with two central and two lateral sections, where each roller section makes contact with its lateral section of the track at a single point, and where a gap is provided between each of the central sections of the track and its associated roller section.

All of the embodiments of the joint according to the subclaims and secondary claims can be used here in analogous fashion with the exception of claim 7. The roller sections can be nonspherical.

Preferred examples of the invention are explained in greater detail below with reference to the drawings.

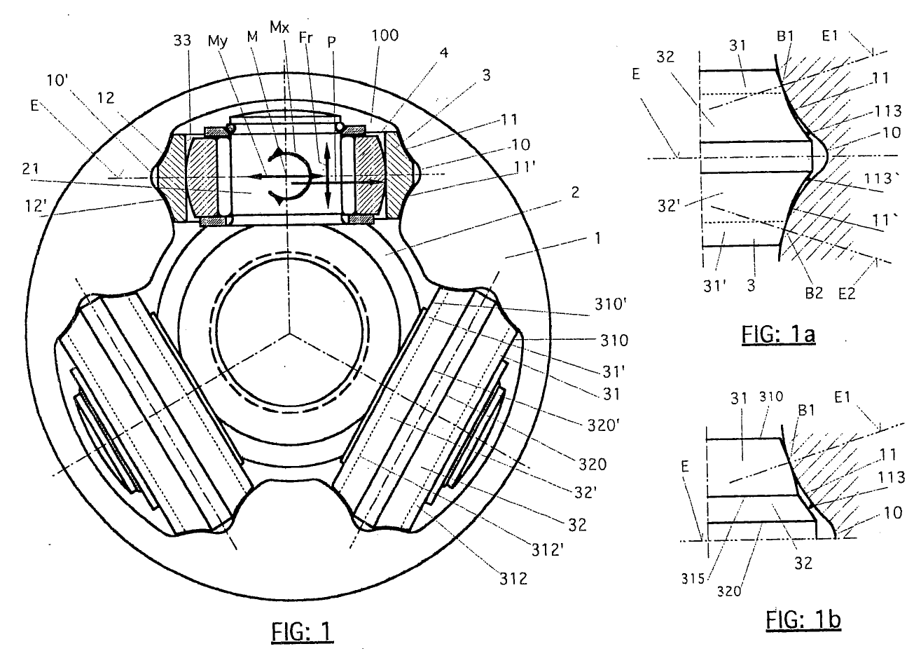

FIG. 1 shows a cross section of a first embodiment of a constant-velocity telescopic joint in accordance with the invention.

FIG. 1a shows a schematic representation of the contours of the outer roller and the track of the joint according to FIG. 1.

FIG. 1b shows a schematic representation of the contours of a simple outer roller for the track of FIG. 1a.

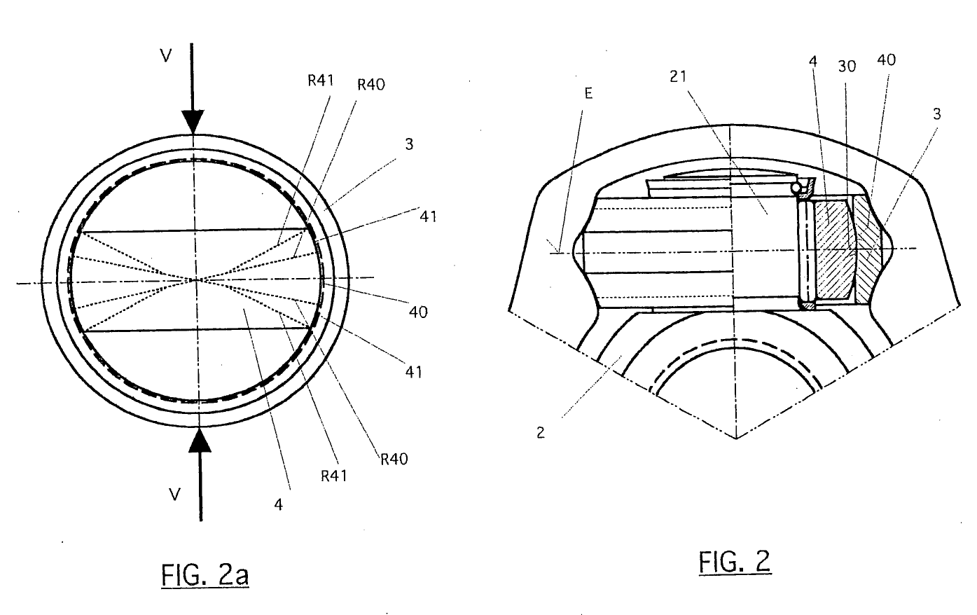

FIG. 2 shows a partial cross section of a second embodiment of a joint in accordance with the invention.

FIG. 2a shows a schematic representation of the joining together of the rollers of a joint according to FIG. 2.

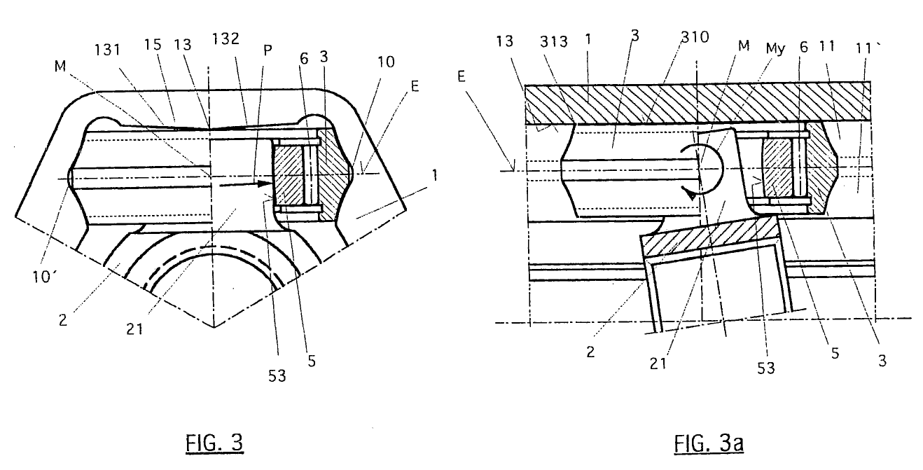

FIG. 3 shows a partial cross section of a third embodiment of a joint in accordance with the invention.

FIG. 3a shows a partial longitudinal section of a joint in accordance with FIG. 3.

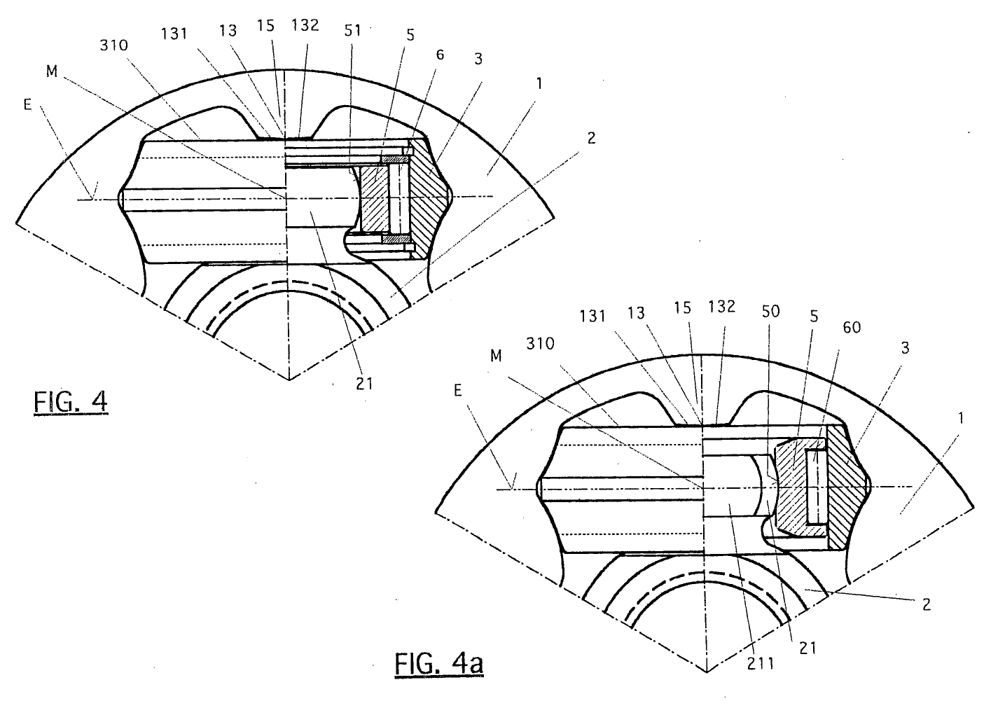

FIG. 4 shows a partial cross section of a fourth embodiment of a joint in accordance with the invention.

FIG. 4a shows a partial cross section of an embodiment of the invention comparable to FIG. 4.

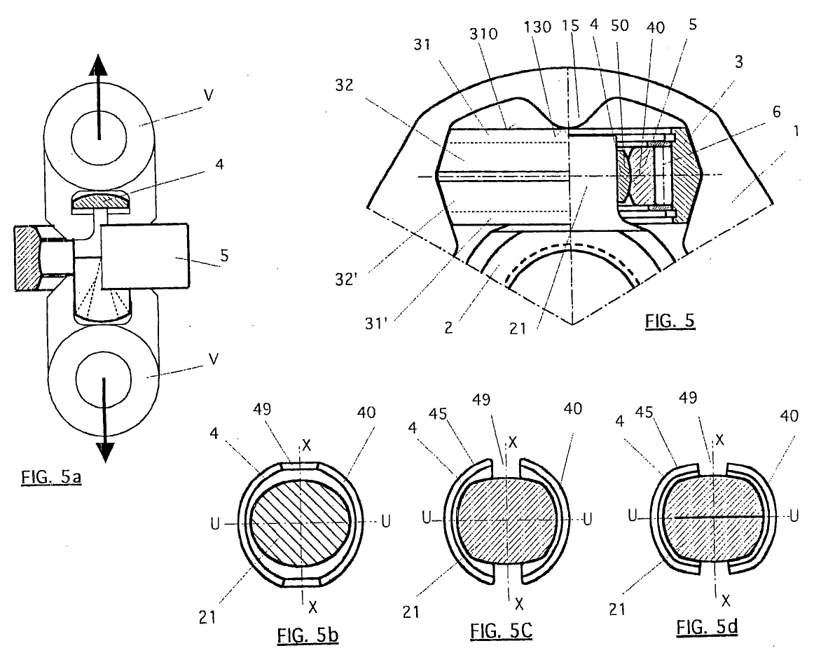

FIG. 5 shows a partial cross section of a fifth embodiment of a joint in accordance with the invention.

FIG. 5a shows a schematic representation of the joining together of two rollers of a joint according to FIG. 5.

FIGS. 5b to 5d each show an alternative arrangement of a journal and a pivot roller according to the fifth embodiment of a joint according to FIG. 5.

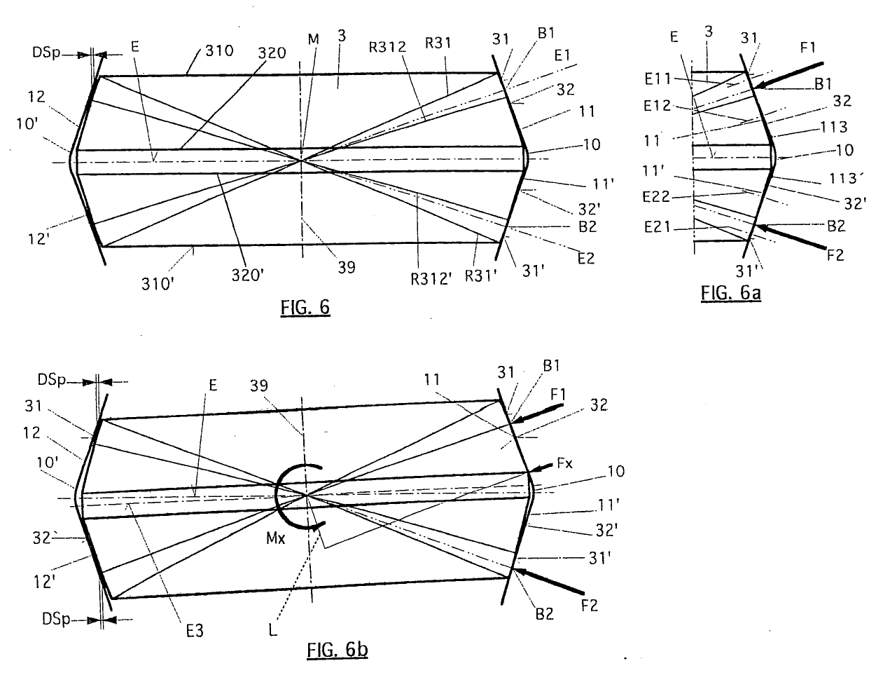

FIG. 6 shows a schematic representation of a first embodiment of an outer roller and a track in accordance with the invention.

FIG. 6a shows a schematic representation similar to FIG. 6, in which the outer roller is shown in a loaded position.

FIG. 6b shows a schematic representation similar to FIG. 6, in which the outer roller is shown in a pivoted position.

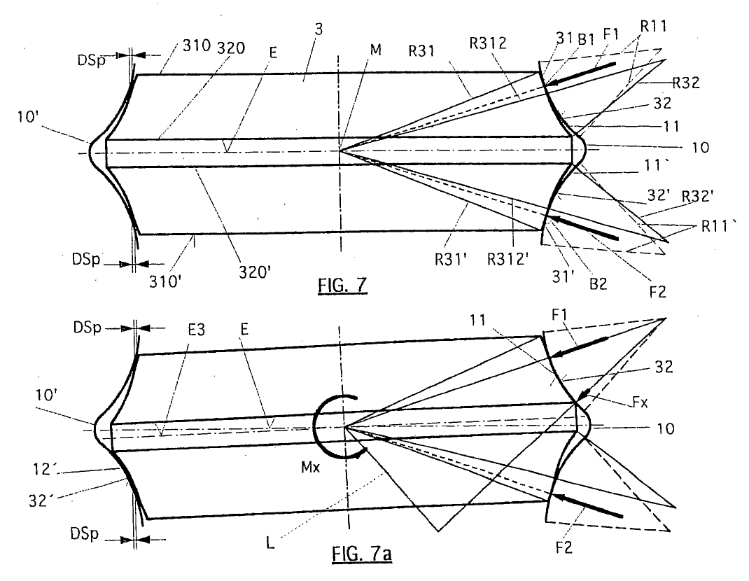

FIG. 7 shows a schematic representation of a second embodiment of an outer roller and a track in accordance with the invention.

FIG. 7a shows a schematic representation similar to FIG. 7, in which the outer roller is shown in a pivoted position.

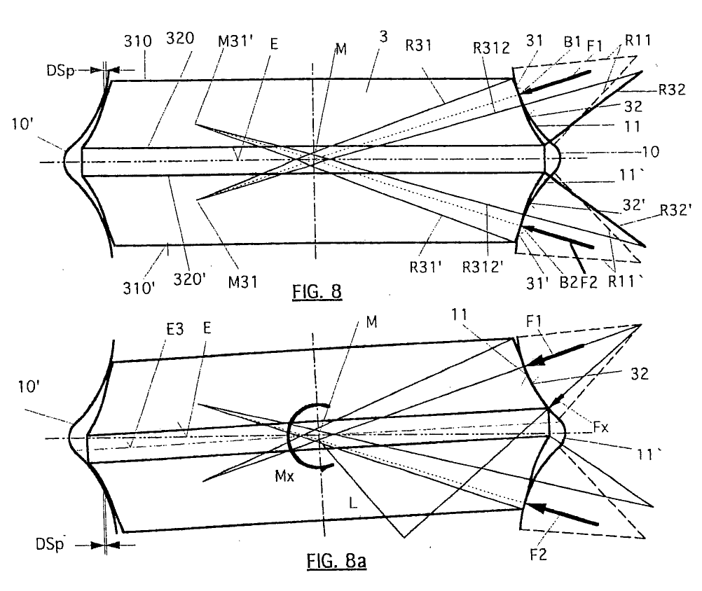

FIG. 8 shows a schematic representation of a third embodiment of an outer roller and a track in accordance with the invention.

FIG. 8a shows a schematic representation similar to FIG. 8, in which the outer roller is shown in a pivoted position.

The constant-velocity joint of FIG. 1 has an outer member 1 with three grooves 100, each of which has two opposite mirror-inverted tracks 10 and 10′. An inner member 2 is arranged coaxially in the outer member 1. The inner member 2 has three radially outwardly directed journals 21 and an outer roller 3 mounted on each journal 21. Each outer roller 3 can rotate, slide, and pivot relative to the journal 21. When the joint is running, the outer roller 3 rolls on one track 10 or the other 10′, depending on the torque direction, this rolling movement being guided along the guide plane E, which connects the tracks 10 and 10′.

The tracks 10 and 10′ are concavely V-shaped, and each has two convex sections 11, 11′ and 12, 12′. The outer rollers 3 are convexly V-shaped with two lateral convex sections 31 and 31′ and two central concave sections 32 and 32′. The lateral section 31 of the outer roller 3 lies between the radially outer flat surface 310 and a radial plane 312, and the central section 32 lies between the radial plane 312 and an edge 320. The lateral section 31′ in turn lies between the radially inner flat surface 310′ and a radial plane 312′, and the central section 32′ lies between the radial plane 312′ and the edge 320′. The outer roller 3 and the tracks 10 and 10′ are arranged symmetrically or in a mirror-inverted way relative to the guide plane E.

The outer roller 3 has a cylindrical bore 33, in which an externally spherical, nonslidable pivot roller 4 is guided, which is mounted by a needle bearing on the journal 21. As it is transmitting torque, the outer roller 3 should be guided by the loaded track, e.g., 10, along the guide plane E as much as possible and should avoid contact with the unloaded track 10′ with the least possible diametrical play. Various tolerance-dependent and kinematically produced alternating moments and alternating forces affect the guidance of the outer roller 3 in the track 10; these forces act one-sidedly on the outer roller 3 and make its guidance more difficult. In the cross section of the outer member 1 (i.e., in a radial plane), for example, the secondary moment Mx about a center M becomes active, which consists of a friction torque and a tilting moment. The friction torque is produced by the relative pivoting movement between the pivot roller 4 and the outer roller 3, and the tilting moment is produced mainly by the displacement, in the radial direction of the joint, of the line contact of the pivot roller 4 with the bore 33 relative to the guide plane E (see displaced transmission force P). An additional secondary moment My occurs in the longitudinal section of the outer member 1 (i.e., in an axial plane), which is caused by the friction of the pivot roller 4 in the bore in the outer roller 3. The force Fr that occurs in the radial direction of the joint and which thus acts axially on the outer roller 3 is produced mainly by the sliding frictional forces between the pivot roller 4 and the outer roller 3.

FIG. 1a shows the outer roller 3 in contact with the track 10. The contact points B1 and B2 between the lateral sections 31 and 31′ and track sections 31 and 31′ lie on the planes of force E1 and E2, which represent the directions in which the force is transmitted. The arc-shaped profiles of the roller sections 31 and 31′ and 32 and 32′ are tangent to each other. A narrow gap 113 and 113′ is provided between each of the central sections 32 and 32′ and the track sections 11 and 11′. As a result of this design, the roller sections 32 and 32′ can assist with the force transmission, even at low torques. The pivoting movement is limited by means of line contact between the roller section 32 or 32′ and the track section 11 or FIG. 1b shows an alternative outer roller 3, in which the central roller section 32 has a conical shape between the edges 315 and 320. The gap is formed in such a way here that the force to be transmitted is transmitted only by the convex roller section 31 (or 31′), even at high torques. The positive limitation of the pivoting movement of the outer roller (3) relative to the outer member 1 takes the form here of point contact between the conical roller section 32 and the track section 11.

FIG. 2 shows a constant-velocity joint similar to that of FIG. 1, with the difference that the pivot roller 4 is supported with freedom to slide on the journal 21 by a needle bearing and is held in a hollow, spherical surface 34 of the outer roller 3. A kinematically produced tilting moment can be avoided in this way. The spherical surface 40 of the pivot roller 4 and the hollow, spherical surface 34 of the outer roller 3 are completely continuous in the circumferential direction, so that the pivot roller 4 can be inserted into the outer roller 3 by an elastic deformation alone. The outer roller 3 is therefore made with a thinner wall, whereas the wall of the pivot roller 4 is much thicker. Even though the wall of the outer roller 3 is thinner, it is still sufficient to transmit the forces in question to the track 10. The wall thickness of the outer roller 3 is less important with respect to the ability of the needle bearing to transmit force; the decisive factor in this regard is the wall thickness of the pivot roller 4.

The assembly operation is explained with reference to FIG. 2a. The pivot roller 4 is inserted transversely into the outer roller 3. The outer roller 3 can be temporarily pressed into an oval shape by means of, for example, a stroke-limited or power-limited device V, and in the meantime the pivot roller 4 can be inserted without resistance into the outer roller 3. However, it is also possible to press the pivot roller 4 transversely into the outer roller 3 (with or without slight auxiliary forces), during which the two rollers would deform differently.

To reduce the deformation and, in case where the rings are assembled by application of pressure, to protect the spherical surface of the pivot roller 4 from damage, a spherical region 40 is provided, as well as two lateral regions 41, which serve as sliding surfaces. The profiles of the three regions are designated in FIG. 2a with their boundary radii R40 and R41 for better representation.

FIGS. 3 and 3a show another joint, in which the outer roller 3 is designed as an outer ring of a needle bearing 6, wherein the bore 53 of the inner ring 5 is formed as a convex crown, and the journal 21 is elliptical with the major axis of the ellipse extending in the direction of rotation. A kinematically produced diametrical play between the major axis of the journal 21 and the convex bore 53 is necessary here, as a result of which the rotational play of the joint is increased. In this embodiment, it is all the more important to minimize the diametrical play of the outer roller 3 in the opposite tracks 10/10′. In addition, this pairing (21/53) has even greater play in the axial direction of the joint, which can also cause noise. Incidentally, the minor axis of the elliptical journal 21 must extend in the axial direction of the joint to create the necessary space for the bending angle of the joint. In addition, the kinematically produced inclination of the point contact between the journal 21 and the bore 53 in the cross section of the joint causes a variable tilting moment (see tilted transmission force P).

Furthermore, the outer member 1 in FIGS. 3 and 3a has a base 15 between the opposite tracks 10 and 10′, which is convexly V-shaped and symmetrical in cross section, with an elevated edge 13 for limiting the pivoting movement of the outer roller 3 in the longitudinal section of the outer member 1. The geometric center M of the outer roller 3 is simultaneously the center of the pivoting movement of the outer roller 3 in the cross section of the outer member 1. Therefore, the play between the edge 13 and the radially outer flat surface 310 of the outer roller 3 can be minimized. In this connection, the base 15 is also capable of absorbing the centrifugal force of the outer roller 3 in the unloaded state.

The flanks 131 and 132 of the base 15 do not come into contact with the flat surface 310 of the outer roller 3. The pivoting movement of the outer roller 3 in the cross section of the outer member 1 is not limited by the base either. If the outer roller 3 in FIG. 3a moves to the right, the left edge 313 of the flat surface 310 is supported on the edge 13 of the base 15. Point contact thus occurs, which, however, owing to the very small angles of inclination of the flat surface 310 and the flanks 131 and 132, is insensitive to wear. In addition, a lubricant film can readily form in this design. Naturally, edges 13 or 313 can also be rounded.

The measures taken to limit the pivoting movement of the outer roller 3 in the longitudinal section of the outer member 1 also have the effect of limiting the sliding component of the friction between the outer roller 3 and the track 10. Of course, the edge friction between the edges 313 and 13 must also be considered. Therefore, depending on circumstances and specifications, it is necessary to decide whether the track friction should be largely eliminated or only partially reduced. In the latter case, greater play between the edge 13 and the flat surface 310 can be prescribed, so that the support of the outer roller 3 in the longitudinal section of the outer member 1 takes effect only after a certain pivot angle has been reached.

FIG. 4 shows a fourth embodiment similar to FIG. 3, in which the bore 51 of the inner ring 5 is cylindrical, and the journal 21 is spherical. The motion of the spherical journal 21 in the cylindrical bore 51 is conventional and also does not promote any kinematically produced play. However, a tilting moment must be expected, which occurs as a result of the displacement, in the radial direction of the joint, of the line contact between the spherical journal 21 and the cylindrical bore 51 with respect to the guide plane E. In addition, the needle bearing 6 is provided with axial play, so that at small bending angles, it, together with the inner ring 5, can handle the reciprocating motion of the spherical journal 21 in the radial direction of the joint with low friction. In this case as well, the outer roller 3 is positively guided in the longitudinal section of the outer member by its flat surface 310 and the edge 13 of the narrow base 15.

In FIG. 4a, the journal 21 is again spherical, but the bore 50 of the inner ring is hollow-spherical. The kinematically produced displacement of the spherical journal 21 in the radial direction of the joint is compensated by the sliding needle bearing 60. Therefore, a tilting moment also acts on the outer roller 3. The flattened area 211 makes it easier to fit the spherical journal 21 into the hollow-spherical bore 50.

FIG. 5 shows an arrangement similar to that of FIG. 3 or FIG. 4, in which an externally spherical pivot roller 4 is inserted between a cylindrical journal 21 and a hollow-spherical bore 50 of the inner ring 5. In addition, the base 15 of the outer member 1 is provided with a rounded edge 130.

The kinematically produced tilting moment can be eliminated due to the pairing of the spherical surface 40 of the pivot roller 4 with the hollow-spherical surface 50. These surfaces are completely continuous in the circumferential direction, so that here, too, the pivot roller 4 can be inserted in the inner ring 5 by means of elastic deformation. Therefore, the pivot roller 4 is designed with a thinner wall, while the wall of the inner ring 5 is made much thicker. A pivot roller 4 with a thinner wall is still perfectly capable of transmitting the forces in question under conditions of two-dimensional contact, and the transmission efficiency of the needle bearing is greatly assisted by the thicker wall of the inner ring 5.

The assembly is explained with reference to FIG. 5a, in which the pivot roller 4 is inserted transversely into the inner ring 5. The more elastic pivot roller 4 can be temporarily squeezed into an oval shape by means of, for example, a stroke-controlled or power-controlled device, and in the meantime the inner ring 5 can be brought into position without resistance. Here, too, however, the pivot roller 4 could also be pressed transversely into the inner ring 5 (with or without slight tensile forces), during which the two rollers would deform accordingly. To facilitate assembly and to protect the spherical surface 40 of the pivot roller 4, the outer surface of the pivot roller 4 can again be divided into a central spherical region and two lateral sliding regions (in this regard, see FIG. 2a).

FIGS. 5b to 5d show three examples of noncircular journals 21 and pivot rollers 4 that fit them, which can be used in the joint shown in FIG. 5. The journals are thicker in the circumferential direction U-U than in the axial direction X-X of the joint, so that both high torques and high maximum bending angles can be achieved. The pivot rollers 4 are mounted nonrotatably on the journals 21 and thus are only capable of sliding along the journals.

The pivot roller 4 in FIG. 5b is provided with two recesses 49, which are arranged in the axial direction X-X of the joint. These recesses 49 allow the pivot roller 4 to be transversely inserted without force into the inner ring 5 along the axis U-U. The recesses 49 are present in the regions of the pivot roller 4 that have thicker walls, so that they do not cause any weakening of the pivot roller 4. Due to the nonrotatable mounting of the pivot roller 4 on the elliptical journal 21, the spherical surfaces 40 always remain aligned in the transmission direction U-U, and the recesses 49 are always away from it. Of course, if the inner ring 5 is rotatably mounted relative to the journal 21, its hollow-spherical inner surface 50 should then be completely continuous in the circumferential direction.

In FIG. 5c, the journal has a cylindrical contour only in the circumferential direction U-U and has the contour of flattened arcs in the axial direction of the joint. The pivot roller 4 consists of two shells 45, which are mounted in the circumferential direction U-U and are mounted nonrotatably relative to the journal. The shells 45 themselves can be easily installed in the inner ring 5 by inserting them through the free space or recesses 49.

The design of FIG. 5d is identical to that of FIG. 5c, except that the shells 45 are formed with a constant wall thickness or cross section, so that they can also be formed from profiled rods.

FIGS. 6, 7, and 8 show various outer rollers 3 with a pair of tracks 10 and 10′, where the outer roller 3 engages the track 10 at two points B1 and B2. The profiles of the central sections 32 and 32′ of the outer roller 3 are tangent to the profiles of the lateral sections 31 and 32′. The radii of curvature of the profiles of the central sections 32 and 32′ are the same as those of the track sections, e.g., 11 and 11′.

The guide plane E is a plane of symmetry for the tracks 10 and 10′ and for the outer roller 3. In addition, the pivot angles or gap angles 113 and 113′ have been exaggerated for purposes of illustration.

FIG. 6 shows a first design of an outer roller 3, which consists of two spherical lateral sections 31 and 31′ and two conical central sections 32 and 32′. The track sections 11 and 11′ of the track 10 are flat. The profiles of the spherical sections 31 and 32 are marked by means of their boundary radii R31 and R312 and R31′ and R312′, respectively, to provide a clearer understanding. The latter meet at the center M of the outer roller 3, so that M is the center of the sphere and is always the center of the pivoting movement of the outer roller 3. The planes of force E1 and E2, which are likewise directed towards the center, are drawn at the contact points B1 and B2 between the outer roller 3 and the track 10. A predetermined diametrical play DSp is provided between the unloaded track 10′ and the outer roller 3.

FIG. 6a shows a segment of the arrangement of FIG. 6 during the transmission of force, in which the main forces F1 and F2 acting on the outer roller 3 by the track 10 are shown. The load causes the original contact points B1 and B2 to expand into contact surfaces, which extend, e.g., to the auxiliary planes E11 and E12 and E21 and E22, respectively. The main force F1 or F2 is thus transmitted by the track section 11 or 11′ to the roller sections 31 and 32 or 31′ and 32′, such that the expansion of the contact surfaces on one side depends primarily on the radius of the roller sections 31 and 31 and on the other side primarily on the gap angle 113 and 113′. The maximum gap width in practice must cover only the relative production tolerances, and the contact surfaces at high loads can simply expand as far as the edges 320 and 320′.

FIG. 6b shows the arrangement of FIG. 6, in which the outer roller 3 is pivoted with its plane of symmetry E3 under the effect of a secondary moment Mx, and in which the conical section 32 rests on the track section 11. The supporting force Fx acting at the end of the line contact acts about the center M with a lever arm L. Naturally, in the case of an actual line contact, the whole contact line is acted upon with the supporting force (Fx), with the transmission force F1, and also with any secondary forces. The contact surface of the outer roller 3 with the track 10, including the contact surface of the main force F2, loads only a small radial region relative to the roller axis 39. The rolling motion of the roller is thus affected with little slippage or sliding friction even when it is supported in the cross section of the outer member 1.

Another outstanding feature of this arrangement concerns the diametrical play DSp, which has remained unchanged after the pivoting movement of the outer roller 3. This means that the pivoting movement in this arrangement requires no systematic diametrical play, regardless of the magnitude of the pivot angle. In practice, the diametrical play thus depends only on the production tolerances and is more or less comparable to that of a simple spherical roller in a simple cylindrical track.

A systematic diametrical play DSp is not necessary here, because the pivot space (e.g., gap 113) on the loaded side of the outer roller 3 corresponds to the pivot space on the diametrically opposite unloaded side (12′/32′ without diametrical play). This happens when the outer roller 3 is designed symmetrically with a center of rotation M, and the diametrically opposite track sections 11 and 12′ or 11′ and 12 are constructed with point symmetry across the center of rotation M.

In FIG. 7, the track sections 11, 11′ are cylindrical-convex. The lateral sections 31, 31′ of the outer roller 3 are spherical, and the profiles of the central sections 32 and 32′ are circularly concave with the same radius as that of the track sections 11 and 11′. The profiles of all sections on the loaded side are marked by means of their boundary radii for the sake of clarity: roller section 31 with R31 and R312; roller section 32 with R312 and R32; roller section 31′ with R31′ and R312′, roller section 32′ with R312′ and R32′; and track section 11 with R11 twice; and track section 11′ with R11′ twice.

FIG. 7a shows the arrangement of FIG. 7, in which the outer roller 3 is pivoted around the center M under the effect of a secondary moment Mx. The concave roller section 32 lies on the convex track section 11 here, and the supporting force Fx at the end of the line contact is also shown here but with a much longer lever arm L than in FIG. 6b due to the shaping of the profiles. Therefore, this shaping is better suited for the support of higher secondary moments and for the guidance of the outer rollers 3.

The diametrical play DSp of the pivoted outer roller 3 also remains unchanged here. A systematic diametrical play is thus unnecessary.

The outer roller 3 of FIG. 8 is basically similar to that of FIG. 7, with the exception that the lateral roller sections 31 and 31′ are designed with larger radii than in the case of the lateral spherical sections of FIG. 7. However, the centers M31 and M31′ of the profiles of the lateral roller sections 31 and 31′ lie on the lines that join the contact points B1 and B2 with the roller center M, so that the center M becomes at least the instantaneous center of rotation of the outer roller 3. With the larger radii of curvature R31 and R31′, the surface pressure is reduced, and the surface contact is increased in the direction of the flat surfaces 310 and 310′.

FIG. 8a shows the arrangement of FIG. 8, in which the outer roller 3 is pivoted around the center M under the effect of a secondary moment Mx. The concave roller section 32 also lies on the convex track section 11 here, and the supporting force Fx at the end of the line contact is likewise shown with the lever arm L. The instantaneous center of rotation of the outer roller 3 has shifted slightly lower, to where the lines of the main forces F1 and F2 acting on the outer roller intersect. This means, above all, that the main forces F1 and F2 produce a moment of resistance that acts against the secondary moment Mx. The diametrical play of the pivoted outer roller 3 decreases slightly in this case.

It can be similarly shown that when the lateral roller sections 31 and 31′ are designed with smaller radii than the spherical sections, an opposite but likewise small effect can occur, in which the moment of resistance acts in the direction of the secondary moment, and the diametrical play increases when the outer roller is pivoted.

The preferred examples show symmetrical outer rollers 3, tracks 10 and 10′, and track sections 11 and 11′ and 12 and 12′. However, asymmetrical designs in accordance with the invention are also conceivable.

List of Reference Numbers

| | |
|---|---|
| 1 | Outer member |
| 10 | Track |
| 10′ | Track |
| 100 | Groove |
| 11 | Track section |
| 11′ | Track section |
| 113 | Gap |
| 113′ | Gap |
| 12 | Track section |
| 12′ | Track section |
| 2 | Inner member |
| 21 | Journal |
| 3 | Outer roller |
| 30 | Spherical bore |
| 31 | Lateral section |
| 31′ | Lateral section |
| 310 | Flat surface |
| 310′ | Flat surface |
| 313 | Edge |
| 315 | Edge |
| 31R | Radius |
| 32 | Central section |
| 32′ | Central section |
| 320 | Edge |
| 320′ | Edge |
| 33 | Cylindrical bore |
| 39 | Roller axis |
| 4 | Pivot roller |
| 40 | spherical surface |
| 41 | Lateral region |
| 45 | Shell |
| 49 | Recess |
| 5 | Inner ring |
| 50 | Spherical bore |
| 51 | Cylindrical bore |
| 53 | Convex bore |
| 6 | Needle bearing |
| 60 | Needle bearing |
| B1 | Contact point |
| B2 | Contact point |
| DSp | Diametrical |
| | play |
| E | Guide plane |
| E1 | Plane of force |
| E2 | Plane of force |
| E3 | Plane of |
| | symmetry |
| E11 | Auxiliary plane |
| E12 | Auxiliary plane |
| E21 | Auxiliary plane |
| E22 | Auxiliary plane |
| F1 | Main force |
| F2 | Main force |
| Fr | Radial force |
| Fx | Supporting |
| | force |
| Mx | Secondary |
| | moment |
| My | Secondary |
| | moment |
| p | Transmission |
| | force |
| R11 | Radius |
| R11′ | Radius |
| R31 | Radius |
| R31′ | Radius |
| R32 | Radius |
| R32′ | Radius |
| R40 | Radius |
| R41 | Radius |
| R312 | Radius |
| R312′ | Radius |
| U—U | Circumferential |
| | direction |
| X—X | Axial direction |
| | of the joint |
| V | Device |

1. Sliding constant-velocity joint with a hollow outer member with three grooves, which extend in the axial direction and are distributed around the circumference, each of which has two opposite tracks, an inner member being positioned in the outer member, the inner member having three radially oriented journals, on each of which is mounted an outer roller, which rolls on one of the tracks, is guided along a plane that connects the opposite tracks, and is mounted slidably and pivotably relative to the journal, wherein the track (10, 10′) is concavely V-shaped with two sections (11, 11′; 12, 12′), and the outer roller (3) is convexly V-shaped with two central sections (32, 32′) and two lateral sections (31, 31′), where the lateral sections (31, 31′) engage the track (10 or 10′) at one contact point (B1, B2) each, and a gap (113, 113′) is provided between each central section (32, 32′) and the corresponding track section (11, 11′), and where the central sections (32 or 32′) and the track sections (11 or 11′) are designed as stop faces for the positive limitation of the pivoting movement of the outer roller (3) relative to the track (10 or 10′) in the cross section of the outer member (1).

2. Constant-velocity telescopic joint in accordance with claim 1, wherein the profiles of the lateral sections (31, 31′) and the central sections (32, 32′) of the outer roller are tangent to each other.

3. Constant-velocity telescopic joint in accordance with claim 1, wherein the profiles of the central sections (32, 32′) of the outer roller and [those of the track sections] (11, 11′, 12, 12′) of the tracks (10, 10′) are of identical design.

4. Constant-velocity telescopic joint in accordance with claim 1, wherein the sections (11, 11′, 12, 12′) of the track (10, 10′) are flat, and the central sections (32, 32′) of the outer roller (3) are conical.

5. Constant-velocity telescopic joint in accordance with claim 1, wherein the profiles of the track sections (11, 11′, 12, 12′) are convexly arched, and the profiles of the central sections (32, 32′) of the outer roller (3) are concavely arched.

6. Constant-velocity telescopic joint in accordance with claim 1, wherein the profile centers (M31, M31′) of the lateral sections (31, 31′) of the outer roller (3) lie on the lines that connect the respective contact point (B1, B2) with the center (M) of the outer roller (3).

7. Constant-velocity telescopic joint in accordance with claim 6, wherein the lateral sections (31, 31′) of the outer roller are spherical.

8. Constant-velocity telescopic joint with a hollow outer member with three grooves, which extend in the axial direction and are distributed around the circumference, each of which has two opposite tracks, an inner member being positioned in the outer member, the inner member having three radially directed journals on each of which an outer roller is mounted, which roller rolls on one of the tracks, is guided along a plane that connects the opposite tracks, and is mounted slidably and pivotably relative to the journal, wherein a base (15) is provided between the opposite tracks (10, 10′), which has a convexly V-shaped and symmetrical design in the cross section of the outer member (1), wherein the central, elevated edge (13) of the base (15) has play with respect to the radially outer flat surface (310) of the outer roller (3), and wherein the deeper lateral flanks (131, 132) of the base (15) always show clearance from the flat surface (310) of the outer roller (3).

9. Constant-velocity telescopic joint in accordance with claim 1, wherein the outer roller (3) has a cylindrical bore (31), in which an externally spherical pivot roller (4) is nonslidably supported on the journal (21) by a needle bearing.

10. Constant-velocity telescopic joint in accordance with claim 1, wherein the outer roller (3) has a hollow-spherical bore (33), in which an outwardly spherical pivot roller (4) is slidably supported on the journal (21) by a needle bearing.

11. Sliding constant-velocity joint according to claim 10, wherein the spherical outer surface (40) of the pivot roller (4) and the hollow-spherical inner surface (30) of the outer roller (3) are completely continuous in the circumferential direction, and in that the average wall thickness of the pivot roller (4) is significantly greater than the average wall thickness of the outer roller (3).

12. Constant-velocity telescopic joint in accordance with claim 1, wherein the outer roller (3) is designed as an outer ring of a nonslidable needle bearing (6), wherein the bore (53) of the inner ring (5) is formed as a convex crown, and the journal (21) is designed with an elliptical cross section.

13. Constant-velocity telescopic joint in accordance with claim 1, wherein the outer roller (3) is designed as an outer ring of a nonslidable needle bearing (6), wherein the inner ring (5) has a hollow-cylindrical (51) design, and the journal (21) has a spherical design.

14. Constant-velocity telescopic joint in accordance with claim 1, wherein the outer roller (3) is designed as an outer ring of a slidable needle bearing (60), wherein the inner ring (5) of the needle bearing (60) has a hollow-spherical (50) design, and the journal (21) has a spherical design.

15. Constant-velocity telescopic joint in accordance with claim 1, wherein the outer roller (3) is designed as an outer ring of a nonslidable needle bearing (6), wherein the inner ring (5) has a hollow-spherical (50) design, and an outwardly spherical, inwardly cylindrical pivot roller (4) is provided between the inner ring (5) and a cylindrical journal (21).

16. Constant-velocity telescopic joint with a hollow outer member with three grooves, which extend in the axial direction and are distributed around the circumference, each of which has two opposite tracks, an inner member being positioned in the outer member, the inner member having three radially directed journals and outer rollers, on each of which an outer roller is mounted, which roller rolls on one of the tracks, is guided along a plane that connects the opposite tracks, and is mounted slidably and pivotably relative to the journal, wherein the outer roller is designed as an outer ring of a nonslidable needle bearing, and wherein the inner ring has a hollow-spherical design, and an outwardly spherical, inwardly cylindrical pivot roller is provided between the inner ring and a cylindrical journal, wherein the spherical surface (40) of the pivot roller (4) and the hollow-spherical surface (50) of the inner ring (5) are completely continuous in the circumferential direction, and the average wall thickness of the pivot roller (4) is significantly smaller than the average wall thickness of the inner ring (5).

17. Constant-velocity telescopic joint with a hollow outer member with three grooves, which extend in the axial direction and are distributed around the circumference, each of which has two opposite tracks, an inner member being positioned in the outer member, the inner member having three radially directed journals on each of which an outer roller is mounted, which roller rolls on one of the tracks, is guided along a plane that connects the opposite tracks, and is mounted slidably and pivotably relative to the journal, wherein the outer roller (3) is designed as an outer ring of a nonslidable needle bearing (6), wherein the inner ring (5) has a hollow-spherical design, and an externally spherical pivot roller (4) is provided between the inner ring (5) and the journal (21), and wherein the pairing of the journal (21) and the pivot roller (4) is designed with a noncircular cross section.

18. Constant-velocity telescopic joint in accordance with claim 17, wherein, in the region of its spherical surfaces (40), the pivot roller (4) has opposite recesses (49), which are arranged in the axial direction (X-X) of the joint.

19. Constant-velocity telescopic joint in accordance with claim 18, wherein the pivot roller (4) consists of two shells (45).

20. Sliding constant-velocity joint according to claim 11, wherein the arc measure of the profile of the hollow-spherical surface (30 or 50) of the outer roller (3) or of the inner ring (5), starting from the vertex plane of the hollow-spherical surface (30 or 50), is about 10°.

21. Constant-velocity telescopic joint in accordance with claim 11, wherein the pivot roller (4) is spherically designed only in a central region (40), whose width approximately corresponds to the width of the hollow-spherical region (30 or 50) of the outer roller (3) or inner ring (5) surrounding it, where the profiles of the lateral regions (41) have less material due to roundings or chamfers than in the case of a continuation of the spherical surface (40).

22. Sliding constant-velocity joint with a hollow outer member with three grooves, which extend in the axial direction and are distributed around the circumference, each of which has two opposite tracks, an inner member being positioned in the outer member, the inner member having three radially oriented journals, on each of which is mounted an outer roller, which rolls on one of the tracks, is guided along a plane that connects the opposite tracks, and is mounted slidably and pivotably relative to the journal, wherein the outer roller (3) is convexly V-shaped with two sections, and the track (10, 10′) is concavely V-shaped with two central sections and two lateral sections, where the roller sections engage the lateral sections of the track (10, 10′) at one contact point (B1, B2) each, and a gap (113, 113′) is provided between each central section of the track and the corresponding roller section, and where the central sections of the track (10, 10′) and the roller sections are designed as stop faces for the positive limitation of pivoting movement of the outer roller (3) relative to the track (10, 10′) in the cross section of the outer member (1).
